(19) United States
(12) Patent Application Publication
(10) Pub. No.: US 2013/0139516 A1
(43) Pub. Date: Jun. 6, 2013

(54) COOLING SYSTEM FOR GAS TURBINE LOAD COUPLING

(71) Applicant: NUOVO PIGNONE S.P.A, Firenze (IT)

(72) Inventors: Filippo Viti, Firenze (IT); Marco Lazzeri, Empoli (IT); Roberto Merlo, Arezzo (IT); Daniele Marcucci, Firenze (IT)

(73) Assignee: NUOVO PIGNONE S.P.A, Firenze (IT)

(21) Appl. No.: 13/687,206

(22) Filed: Nov. 28, 2012

(30) Foreign Application Priority Data
Dec. 2, 2011 (IT) FI2011A000257

(51) Int. Cl. F02C 7/18

(52) U.S. Cl. CPC F02C 7/18
USPC 60/772; 60/39.83

(57) ABSTRACT

A gas turbine is provided. The gas turbine comprises a compressor, a power turbine, a load coupling connecting the gas turbine to a load, a gas turbine package comprising a turbomachinery compartment housing the gas turbine, a load-coupling guard at least partly surrounding the load coupling, a cooling air circulation system for circulating cooling air in the turbomachinery compartment, and a cooling air channeling configured to circulate a cooling air flow from the cooling air circulation system in the load-coupling guard sufficient to remove heat from the load coupling.

### BACKGROUND OF THE INVENTION

The present disclosure relates generally to gas turbines such as, in particular, but not exclusively, to aeroderivative gas turbines. More specifically, the disclosure relates to industrial applications of aeroderivative gas turbines, for power generation, natural gas liquefaction or similar industrial applications.

Aeroderivative gas turbines are widely used as power sources for mechanical drive applications, as well as in power generation for industrial plants, pipelines, offshore platforms, LNG applications and the like.

FIG. 1 illustrates a schematic representation of a system including a gas turbine and a load mechanically driven by said gas turbine. More specifically, in the diagrammatic representation of FIG. 1 reference 1 indicates a gas turbine which drives a load, for example a compressor or a compressor train for a natural gas liquefaction line, schematically shown at 3. The gas turbine 1 is connected to the load 3 by means of a load coupling 5. The load coupling 5 comprises a shaft 7 and a joint 9. In the example of FIG. 1 the shaft 7 rotatingly driven by the gas turbine 1 is connected to a gear box 11. An output shaft 13 of said gear box 11 connects the gear box 11 to the load 3. The load 3 can include a single rotary machine, for example, a compressor, or an electric generator, or else a set of rotary machines on the same shaft. A further gear box can be arranged between two adjacent rotary machines driven by the turbine 1.

The gas turbine 1 comprises a gas generator 15 and a power turbine 17. The gas generator 15 comprises in turn a compressor 19, a combustion chamber 21 and a high pressure turbine 23. The air entering the compressor 19 is compressed at high pressure and added with a liquid or gaseous fuel in the combustion chamber 21. The compressed and high temperature combustion gases are expanded first in the high pressured turbine 23, which is connected through an internal shaft 25 to the compressor 19. The expansion of the combustion gases in the high pressure turbine 23 generates mechanical power, which drives into rotation the compressor 19. The partly expanded combustion gases exiting the high pressured turbine 23 enter the power turbine 17 and further expand to generate mechanical power, which drives the load 3 through the load coupling 5. The exhausted combustion gases are collected by a collector-diffuser and discharged through a discharge line 27.

In the example shown in FIG. 1 the gas turbine is a single shaft gas turbine, that is, a gas turbine wherein a single internal shaft 25 connects the high pressure turbine 23 to the compressor 19 of the gas generator 15. The power turbine, sometimes also named low pressure turbine, is supported by a shaft that is separate from the internal shaft 25 such that the gas generator 15 can rotate independently of and at a different speed than the power turbine 17. Other gas turbine embodiments provide for a different number of internal shafts and the gas generator can comprise a different number of compressors and turbines driving the compressors.

These turbines are typically aeroderivative turbines.

In the exemplary embodiment of FIG. 1 the load 3 is connected through the load coupling 5 to the so-called hot end of the gas turbine 1, that is, the gas turbine side where the power turbine 17 is arranged, to be distinguished from the cold end, corresponding to the side of compressor 19.

The load-coupling 5 is subject to temperature deformations due to high temperatures at the hot end of the gas turbine 1. Thermal deformation of the shaft 7 must be sagged, that is, measures must be adopted to prevent the thermal expansion of the shaft 7 to damage the load bearings of either the power turbine 17 or the machinery arranged on the load side, that is, the bearings of the gear box 11 (if present) and/or of the rotary machines 3 driven by the gas turbine 1. Commonly adopted measures include arranging a joint which can compensate for the thermal expansion of the shaft. Thermal expansion of the shaft nevertheless generates axial forces on the bearings on both sides of the joint, that is, on the turbine bearings and on the gearbox or rotary machine bearings.

JP-2000-291446 discloses a gas turbine with a load-coupling cooling system, including fan blades mounted on the load coupling. The fan blades are driven into rotation by the load coupling and generate a stream of cooling air from the environment through a guard surrounding the load coupling. Using fan blades driven by the load coupling removes the need for an additional compressor or fan for cooling the load coupling. However, the blades modify the rotodynamic behavior of the load coupling and can negatively affect the correct operation thereof, leading to dynamic stresses, vibration and potential failure of the rotating components and relevant supports.

A need therefore exists for a more efficient load-coupling cooling system.

### BRIEF DESCRIPTION OF THE INVENTION

As will be described here below, reference being made to some embodiments of the invention, a particularly efficient arrangement is provided for delivering a stream of cooling air in a volume at least partly surrounding at least a portion of the load coupling connecting the gas turbine and the load, heat is actively removed by forced air convection from the load coupling, thus reducing the thermal deformation of the load connection and therefore reducing the axial load on the turbine and load bearings.

According to some embodiments of the subject matter disclosed herein, a gas turbine is provided. The gas turbine comprises a compressor, a power turbine, a load coupling connecting the gas turbine to a load, a gas turbine package comprising a turbomachinery compartment housing the gas turbine, a load-coupling guard at least partly surrounding the load coupling, a cooling air circulation system for circulating cooling air in the turbomachinery compartment, and a cooling air channeling configured to circulate a cooling air flow from the cooling air circulation system in the load-coupling guard sufficient to remove heat from the load coupling.

According to another embodiment of the subject matter disclosed herein, a method of reducing heat and mechanical stresses on a load coupling in a gas turbine is provided. The gas turbine comprises at least a compressor, a power turbine arranged in a turbomachinery compartment of a gas turbine package, and a load coupling which connects the gas turbine to a load. The method comprises generating a cooling air stream to cool a casing of the gas turbine, and diverting a fraction of the cooling air stream upstream of the turbomachinery compartment and forcing the fraction of cooling air stream around the load coupling for removing heat from the load coupling by forcing cooling air around the load coupling.

According to another embodiment of the subject matter disclosed herein, a gas turbine is provided. The gas turbine comprises a compressor, a power turbine, a load coupling connecting the gas turbine to a load, a load-coupling guard at least partly surrounding the load coupling, a cooling air channeling configured to circulate a cooling air flow in the load-coupling guard sufficient to remove heat from the load coupling, a gas turbine package comprising a turbomachinery compartment housing the gas turbine, a cooling air circulation system configured to circulate cooling air in the turbomachinery compartment, and a load compartment, the load coupling extending through the load compartment. The cooling air channeling comprises an air port, wherein cooling air from the cooling air circulation system is forcedly circulated through the airport. At least a first ventilation duct fluidly connects the air port to the load-coupling guard and a second ventilation duct feeds cooling air in the load compartment.

According to a further aspect, the subject matter disclosed herein relates to a method of reducing heat and mechanical stresses on a load coupling in a gas turbine. The gas turbine comprises at least a compressor; a power turbine; and a load coupling connecting the gas turbine to a load. According to some embodiments, the method comprises removing heat from the load coupling by forcing cooling air around the load coupling.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a gas turbine and compressor arrangement according to the state of the art;

FIG. 2 illustrates a gas turbine and compressor arrangement according to an embodiment of the disclosure;

FIG. 3 illustrates a schematic section according to a vertical plane of the arrangement of FIG. 2;

FIG. 4 illustrates a cross-section according to line IV-IV in FIG. 3; and

FIG. 5 illustrates an embodiment of a gas turbine and load arrangement according to the present disclosure.

### DETAILED DESCRIPTION OF EXEMPLARY EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

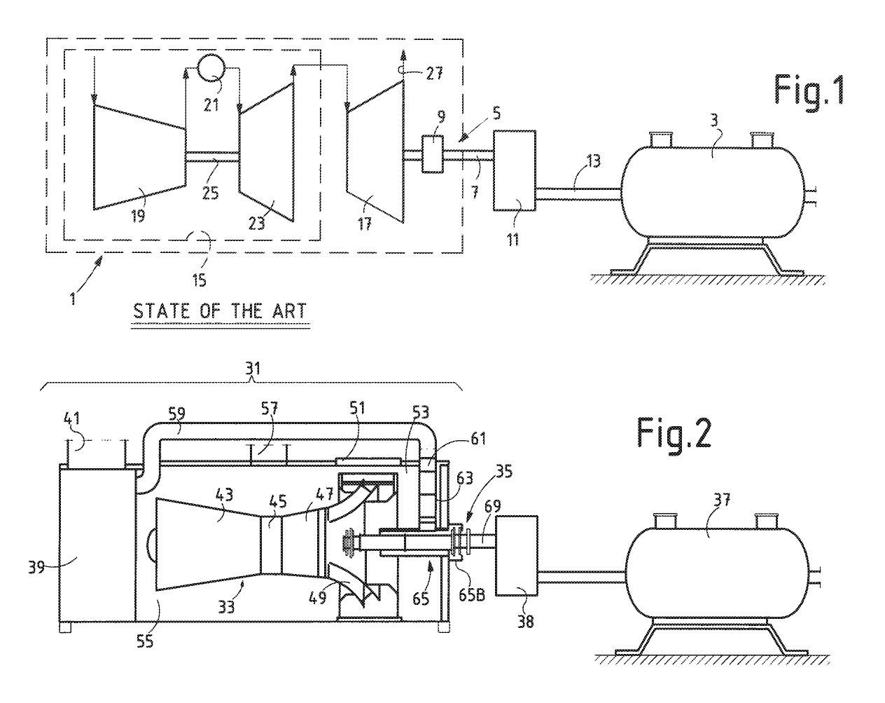

FIG. 2 schematically illustrates a system embodying the subject matter disclosed herein. The system comprises a gas turbine and a load connected to the gas turbine by means of a load coupling. More specifically in the diagrammatic representation of FIG. 2, a gas turbine package 31 comprising a gas turbine 33 is connected by means of a load coupling 35 to a load 37. In the exemplary embodiment illustrated in FIG. 2 the load 37 is represented as a compressor, such as a compressor for a refrigerant of a natural gas liquefaction system. In the exemplary embodiment illustrated in FIG. 2 a gearbox 38 is arranged between the gas turbine and the compressor 37. The compressor 37 can be one of a series of compressors forming a compressor train driven by the same gas turbine 33. It shall be understood that a different kind of load can be driven by the gas turbine. For example the load can be an electric generator of a power generation plant. The load coupling can include one or more gearboxes and/or one or more rotary machines, such as electric machines or turbomachines.

In the exemplary embodiment shown in FIG. 2, the gas turbine package 31 comprises an air intake plenum 39 in fluid communication with an air intake line 41 and with the inlet side of a compressor 43 of the gas turbine 33. The gas turbine 33 can be comprised of a high pressure turbine 45 and a power turbine 47. The high pressure turbine 45 is drivingly connected to the compressor 43 by an internal shaft (not shown). Combustion gases generated in the combustion chamber of the gas turbine expand sequentially in the high pressure turbine 45 to generate the power required to drive the compressor 43 and subsequently in the power turbine 47, to drive the load 37. Different gas turbine arrangements can be used, for example including two or more compressors in sequence and more than two turbines in series on the hot side of the gas turbine 33. In general terms, the gas turbine 33 comprises a gas generator comprised of at least one compressor 43 and a high pressure turbine 45, said gas generator providing combustion gases at high temperature and high pressure, which are expanded in one or more turbines 47.

In some embodiments the gas turbine 33 can be an aeroderivative gas turbine. The overall structure and layout, including the number of compressors, the number of turbines, the number of shafts, the number of compression and expansion stages of the aeroderivative gas turbine can vary from one aeroderivative gas turbine to the other. Suitable aeroderivative gas turbines are LM2500+G4 LSPT or LM2500 aeroderivative gas turbines, both commercially available from GE Aviation, Evendale, Ohio, USA. Other suitable aeroderivative gas turbines are the PGT25+G4 aeroderivative gas turbine commercially available from GE Oil and Gas, Florence, Italy, or the Dresser-Rand Vectra® 40G4 aeroderivative gas turbine commercially available from Dresser-Rand Company, Houston, Tex., USA, for example. In other embodiments, the aeroderivative gas turbine can be a PGT16, a PGT 20, all commercially available from GE Oil and Gas, Florence, Italy or an LM6000 aeroderivative gas turbine, commercially available from GE Aviation, Evendale, Ohio, USA.

The expanded and exhausted combustion gases are collected in an exhaust diffuser-collector assembly 49 and discharged towards the environment through a discharge line 51.

In the exemplary embodiment shown in the drawings, the exhaust diffuser-collector assembly 49 is arranged in a load compartment 53. The load compartment 53 is arranged at the opposite side of the gas turbine package 31 with respect to the intake plenum 39, that is, at the hot end side of the gas turbine. The load coupling 35 extends from the power turbine 47 through the exhaust diffuser-collector assembly 49 which therefore at least partly surrounds the load coupling 35.

Part of the air sucked through the air intake plenum 39 at the cold end side of the gas turbine 33 flows through the gas turbine package 31 and, more specifically, through a turbomachinery compartment 55 forming the intermediate portion of the gas turbine package 31 and housing at least partly the gas turbine 33. The air circulating in the turbomachinery compartment 55 cools the casing of the turbine machinery and is exhausted through an exhaust cooling air line 57.

In some embodiments, part of the cooling air sucked in the turbomachinery compartment 55 is deviated in an air duct 59 which is in fluid communication with an air port 61.

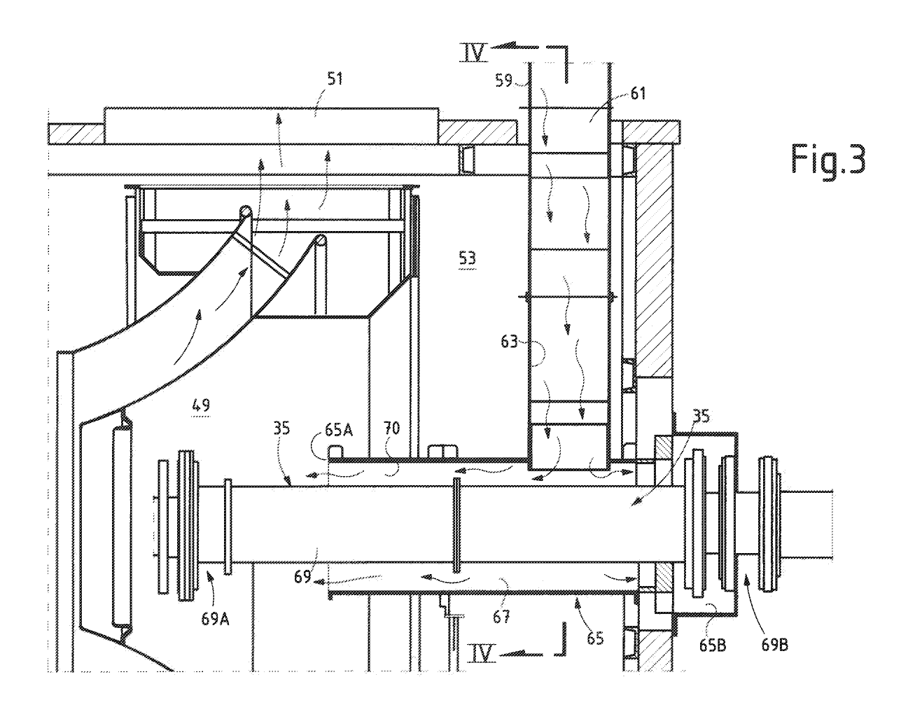

In the exemplary embodiment shown in the drawing, an air ventilation duct 63 fluidly connects the air port 61 with a load-coupling guard 65, the structure of which can best be seen in FIG. 3. In some embodiments the load-coupling guard 65 is comprised of a cylindrical shell or sleeve 67 surrounding at least partly a shaft 69 forming part of the load-coupling 35.

In some embodiments the load-coupling guard 65 comprises a first end 65A facing towards the gas turbine 33 and a second end 65B facing the load 37. At least one end and preferably both ends 65A and 65B can be open, such that, cooling air which is forcedly circulated through the air port 61 and the ventilation duct 63 escapes from a confined volume or space delimited by the cylindrical shell or sleeve 67 of the load-coupling guard 65, said volume being indicated with reference number 70. In some embodiments the first end 65A of the load-coupling guard is oriented such that air escaping the first end 65A is forced against the exhaust diffuser-collector assembly 49. In some embodiments the second end 65B of the load-coupling guard 65 can be open towards the environment, outside the turbine package, such that a part of the cooling air forcedly circulating in the confined volume surrounding the load coupling is vented in the environment.

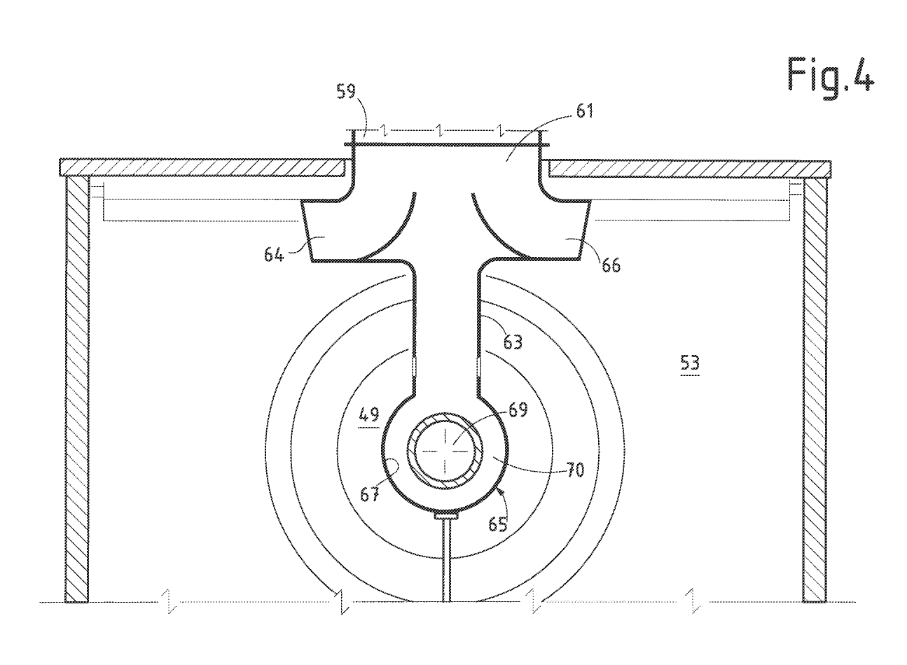

In some embodiments the air port 61 is additionally in fluid communication with a second ventilation duct 64 and possibly with a third ventilation duct 66 (see FIG. 4).

The second and third ventilation ducts 64 and 66 comprise open ends arranged in the load compartment 53, such that air forced into the ventilation ducts 64, 66 is vented in the load compartment 53. The air circulating in the load compartment cools the load compartment 53 and any apparatus arranged therein.

With the above described arrangement, cooling air forced by the cooling air circulating system through the air duct 59 is caused to enter the first ventilation duct 63 as well as the second and/or third ventilation ducts 64 and 66, if present. The air stream conveyed by the first ventilation duct 63 into the volume 70 surrounding the load coupling 35 cools the load coupling 35 and more specifically the shaft 69 surrounded by the load-coupling guard 65. An air flow escaping from both ends 65A and 65B of the load-coupling guard 65 is forced to remove heat also from both portions of the shaft 69 extending from the load-coupling guard 65 and of one or more joints arranged on said shaft 69 outside of the load-coupling guard 65. Additionally, the air escaping from the open end 65A of the load-coupling guard 65 is oriented towards the exhaust diffuser-collector assembly 49, maintaining the temperature in the area surrounding the load-coupling 35 at a reduced temperature.

The temperature of the cooling air and the rate of the cooling air flow maintain the temperature of the load coupling 35 and more specifically of the shaft 69 at such a value to reduce substantially the axial load on the bearings of the shaft both on the turbine sides as well as on the load side.

As can be appreciated in particular from FIG. 3 in some embodiments the open end 65A of the load-coupling guard 65 is arranged within the hollow part of the exhaust diffuser-collector assembly 49 through which the load coupling 35 extends. In this manner an efficient cooling air stream exiting the tubular load-coupling guard 65 is directed along the proximal end of the shaft 69, and possibly a joint 69A arranged between the shaft 69 and the hot end of the gas turbine 33 just in that area where the highest heat load is present, said heat load being caused by the hot exhausted gases collected by the exhaust diffuser-collector assembly 49 and deviated towards the discharge line 51.

FIG. 4 schematically illustrates a further joint 69B arranged on the load coupling 35 in the area of the second open end 65B of the load-coupling guard 65. Also in this area, the forced cooling air stream escaping the open end 65B provides for an efficient cooling of this area of the load coupling 35.

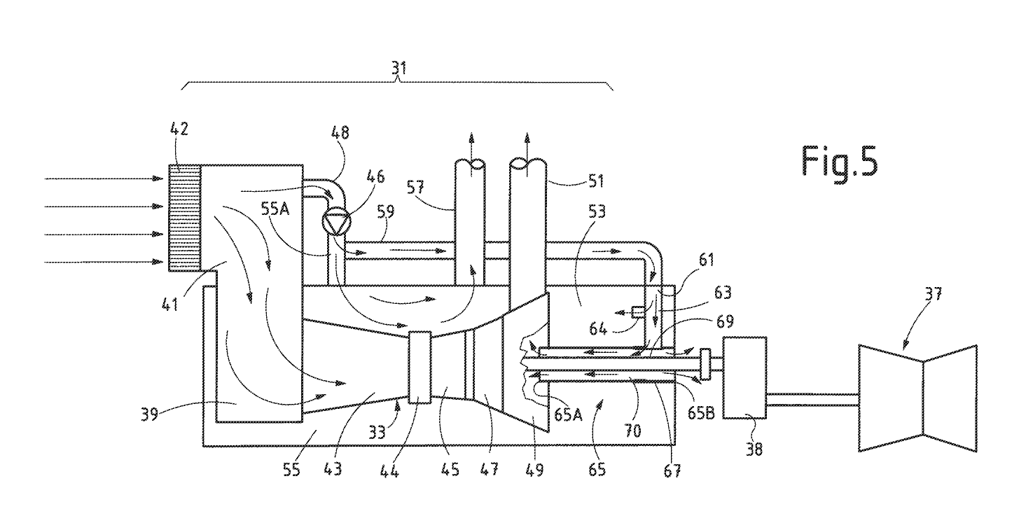

FIG. 5 schematically illustrates a further embodiment of the gas turbine and load arrangement according to the present disclosure. The same reference numbers are used to designate the same or similar parts, components or elements described here above in connection with FIG. 2.

The system comprises a gas turbine package 31 comprising a gas turbine 33 connected by means of a load coupling 35 to a load 37. In the exemplary embodiment illustrated in FIG. 5 the load 37 comprises a compressor, for example, a compressor for a refrigerant of a natural gas liquefaction system. A gearbox 38 can be arranged between the gas turbine and the compressor 37. In other embodiments a direct drive between the gas turbine and the load can be provided or a different speed manipulation device can be used instead of a gearbox. The compressor 37 can be one of a series of compressors forming a compressor train driven by the same gas turbine 33. It shall be understood that a different kind of load can be driven by the gas turbine. For example the load can be an electric generator of a power generation plant. The load coupling can include one or more gearboxes and/or one or more rotary machines, such as electric machines or turbomachines.

The gas turbine package 31 comprises an air intake plenum 39 in fluid communication with an air intake line or duct 41 and with the inlet side of a compressor 43 of the gas turbine 33. A filter arrangement 42 usually provided at the inlet of the air intake line or duct 41 is also shown in FIG. 5.

The gas turbine 33 can be comprised of a high pressure turbine 45 and a power turbine 47. The high pressure turbine 45 is drivingly connected to the compressor 43 by an internal shaft (not shown). Combustion gases generated in a combustion chamber 44 of the gas turbine expand sequentially in the high pressure turbine 45 to generate the power required to drive the compressor 43 and subsequently in the power turbine 47, to drive the load 37. Different gas turbine arrangements can be used, for example including two or more compressors in sequence and more than two turbines in series on the hot side of the gas turbine 33. In general terms, the gas turbine 33 comprises a gas generator comprised of at least one air compressor 43 and a high pressure turbine 45, said gas generator providing combustion gases at high temperature and high pressure, which are expanded in one or more power turbines 47. The power turbine(s) can be mechanically connected to the shaft of the high pressure turbine and compressor. In alternative embodiments, the power turbine 47 can be mechanically separate from the gas generator, i.e. the gas generator shaft and the power turbine shaft can be mechanically independent from one another.

The expanded and exhausted combustion gases are collected by an exhaust diffuser-collector assembly 49 and discharged towards the environment through a discharge line or stack 51.

The exhaust diffuser-collector assembly 49 can be arranged in a load compartment 53, which is arranged opposite the intake plenum 39, i.e. at the hot end side of the gas turbine 33. The load coupling 35 extends from the power turbine 47 through the exhaust diffuser-collector assembly 49 which therefore at least partly surrounds the load coupling 35.

Combustion air is sucked through the filter arrangement 42 and the air intake line or duct 41 in the intake plenum 39 by the compressor 33.

Through the same air intake line or duct 41 and the filter arrangement 42 fresh ambient air is also delivered towards the interior of the gas turbine package 31, and more specifically through the turbomachinery compartment 55 for cooling purposes. Fresh ambient air is further delivered from the air intake line or duct 41 towards a load-coupling cooling arrangement, as will be described in greater detail here below.

In some embodiments, a single fan, compressor, or any other air forcing or air propelling device, schematically shown at 46, is provided in a ventilation air duct 48, which is in fluid communication with the air inlet line 41. An air forcing or air propelling device shall be understood as any device suitable to deliver a sufficient air flowrate at a sufficient air pressure for the purposes described here below. Air sucked by the fan 46 from the air inlet line 41 is forced or propelled through a duct 55A to a turbomachinery compartment 55 forming the intermediate portion of the gas turbine package 31 and at least partly housing the gas turbine 33. The air circulating in the turbomachinery compartment 55 cools the casing of the turbine machinery and is exhausted through an exhaust cooling air line 57.

In some embodiments, part of the cooling air sucked in the turbomachinery compartment 55 is deviated in an air duct 59 which is in fluid communication with an air port 61. In the exemplary embodiment shown in FIG. 5, an air ventilation duct 63 fluidly connects the air port 61 with a load-coupling guard 65, which can have the same structure disclosed here above in connection with FIGS. 2 to 4. In some embodiments the load-coupling guard 65 is comprised of a cylindrical shell or sleeve 67 at least partly surrounding a shaft 69 forming part of the load coupling 35.

Also in the embodiment of FIG. 5 the guard 65 comprises a first end 65A facing towards the gas turbine 33 and a second end 65B facing the load 37. At least one end, and in some embodiments, both ends 65A and 65B can be open, so that cooling air circulating through the air port 61 and the ventilation duct 63 escapes from a confined volume or space 70 delimited by the cylindrical shell or sleeve 67 of the load-coupling guard 65. In some embodiments the first end 65A of the load-coupling guard is oriented so that air escaping the first end 65A is forced against the exhaust diffuser-collector assembly 49. In some embodiments the second end 65B of the load-coupling guard 65 can be open towards the environment, outside the turbine package, so that a part of the cooling air forcedly circulating in the confined volume surrounding the load coupling is vented in the environment.

In some embodiments the air port 61 is additionally in fluid communication with a second ventilation duct 64 and possibly additional ventilation ducts, not shown. The ventilation duct(s) 64 opens in the load compartment 53, so that air forced into the ventilation duct 64 is vented in the load compartment 53. The air circulating in the load compartment cools the load compartment 53, the surface of exhaust collector-diffuser assembly 49 and any apparatus arranged in the load compartment 53.

In the embodiments of both FIGS. 2-4 and FIG. 5 a single air source is therefore provided, for delivering cooling air through the gas turbine package and the turbomachinery compartment 55 in particular, as well as to the load-coupling guard surrounding the load coupling. A single fan, compressor or ventilator can be provided for forcedly circulating cooling air both around the turbomachine casing in the turbomachinery compartment 55 as well as around the load coupling. In some embodiments, the air is taken from the air inlet line or duct 41.

In some embodiments, a single filter arrangement 42 is provided for filtering both the combustion air ingested by the compressor 43 of the gas turbine 33, as well as the cooling air circulating in the gas turbine package, and specifically in the turbomachinery compartment 55 for cooling the turbomachine casing, as well as around the load coupling.

A compact arrangement having reduced manufacturing and maintenance costs is obtained.

The forced air convection provided in the load-coupling guard removes heat from the load coupling and maintains the load coupling at low temperature, thus reducing the overall thermal deformation of the load coupling. In this way axial loads generated by thermal expansion of the load bearing are reduced also when the gas turbine is connected to the load via said load coupling on the hot end of the gas turbine, that is, on the side of the power turbine rather than on the side of the compressor.

The present disclosure provides a gas turbine comprising: a compressor; a power turbine and a load coupling which connects the gas turbine to a load (37). A gas turbine package is further provided, comprised of a turbomachinery compartment housing the gas turbine. A load-coupling guard is arranged around the load coupling to at least partly surrounding said load coupling. A cooling air circulation system is arranged and configured for circulating cooling air in the turbomachinery compartment. The cooling air circulation system delivers fresh ambient air in the turbomachinery compartment to cool the turbomachine casing, i.e. the casing of the compressor and of the turbine(s) arranged therein. Moreover, a cooling air channeling is also provided for cooling the load coupling. The cooling air channeling is designed and arranged to circulate a cooling air flow taken from the cooling air circulation system in the load-coupling guard. The air flow circulating in the load-coupling guard is sufficient to remove heat from said load coupling and reduce the thermal and mechanical stresses thereof. In some embodiments, the cooling air channeling is designed and configured to divert a fraction of the ambient air delivered by the cooling air circulation system upstream of the turbomachinery compartment, i.e. before the fresh ambient air enters the turbomachinery compartment. The air delivered by the cooling air channeling towards the load-coupling guard is thus nearly at ambient temperature, thus achieving improved cooling of the load coupling.

A single air forcing device can be arranged and designed for forcing cooling air in the turbomachinery compartment and through the cooling air channeling in said load-coupling guard. A simple construction with a limited number of auxiliary facilities is thus required to perform cooling of both the turbomachinery casing and the load coupling. The efficiency of the system is improved, the overall reliability thereof is enhanced. A more compact arrangement is also achieved. A separate air forcing device for delivering cooling air to the load coupling can be dispensed with, since the cooling air flow around the load coupling is generated by the same air forcing device which is provided for turbomachinery cooling. Additionally, no fan blades are required to be mounted on the load coupling, as in the above mentioned prior art arrangements.

In some embodiments an air intake line or duct can be provided and arranged in fluid communication with the cooling air circulation system and with said cooling air channeling. The air intake line can be provided with a filter arrangement at the inlet thereof. The filter arrangement filters both the ambient air required for cooling the turbomachinery casing, as well as the ambient air required for cooling the load coupling. No separate filter arrangement is required. In some embodiments, the air intake line is in fluid communication with an air intake plenum, from which combustion air enters the compressor of the gas generator of the gas turbine. This further improves the efficiency of the system reducing the costs thereof, as a single filter arrangement filters the entire cooling air flow as well as the combustion air flow.

In some preferred embodiments, the gas turbine is an aeroderivative gas turbine. The gas turbine can be a single-shaft gas turbine, that is, a gas turbine wherein the compressor is mechanically driven by a high pressure gas turbine, wherein the compressor and the high pressure gas turbine are supported on a common shaft. The compressor and high pressure gas turbine form a gas generator. The exhaust combustion gases exiting the high pressure turbine are further expanded in the power turbine. The power turbine is supported on an independent shaft and drives into rotation a load. In some embodiments a gear box is arranged between the power turbine and the load.

In other embodiments the gas turbine can be a dual-shaft or a three-shaft gas turbine, comprising two or three compressors and two or three turbines, with co-axial shafts connecting the turbines and shafts to one another.

Irrespective of the number of compressors and turbines, and from the number of co-axial shafts, a load coupling is provided between the power turbine, that is, the turbine providing power to drive the load, and the load, with possible interposition of a gear box to drive the load and the power turbine at different rotational speeds. The load coupling commonly comprises at least a shaft and one or more joints. The shaft can be comprised of one or more shaft sections or shaft portions, connected to one another.

In some embodiments the load coupling and the load-coupling guard extend through an exhaust gas plenum or exhaust collector-diffuser assembly, which at least partly surrounds the load coupling and the load-coupling guard. The exhaust collector-diffuser assembly develops around the axis of the gas turbine and collects the exhausted and expanded combustion gases to discharge them in the environment or convey the expanded, high temperature combustion gases, for example, towards a steam turbine or another section of a co-generation plant.

In some embodiments, the gas turbine is at least partly arranged in a gas turbine package comprised of a turbomachinery compartment housing the gas turbine. In some embodiments, an air circulation system is further provided, for circulating cooling air in the turbomachinery compartment. A load compartment is preferably arranged downstream of the turbomachinery compartment. The load compartment is arranged on a side of the turbomachinery compartment. An opposite air intake plenum is arranged on the opposite side of the turbomachinery compartment, to allow air in the compressor of the gas turbine and in the turbomachinery compartment, to cool the exterior of the turbomachinery casing. The load coupling which connects the gas turbine and the load preferably extends through the load compartment. The load-coupling guard may receive air from the cooling air circulation system or other dedicated sources.

The cooling air channeling can comprise an air port, wherein cooling air from the cooling air circulation system is forcedly circulated. At least a first ventilation duct fluidly connects the air port to the load-coupling guard and in some embodiments a second and possibly a third ventilation duct is provided, in fluid communication with the load compartment to allow forced air circulation in the load compartment.

The load-coupling guard can be open ended at both ends, such that the air forcedly circulating in the volume delimited by the load-coupling guard can escape at both ends of the load-coupling guard. This enhances cooling of the load coupling also in portions thereof extending outside the load-coupling guard.

In some embodiments, a method is provided, for reducing heat and mechanical stresses on a load coupling in a gas turbine. The method advantageously comprises the following steps: generating a cooling air stream to cool a casing of the gas turbine; diverting a fraction of the cooling air stream upstream of a turbomachinery compartment where the gas turbine is arranged, and forcing said fraction of cooling air stream around a load coupling, which connects the gas turbine to a load,for removing heat from said load coupling.

In some embodiments, the method comprises: defining a confined volume at least partly surrounding the load coupling; and forcedly circulating cooling air in the confined volume to remove heat from the load coupling. It shall be understood that heat is usually removed from one portion of the load coupling only, that is, the portion nearest to the hot end of the gas turbine, since thermal expansion is concentrated in the section of the load coupling.

In an exemplary embodiment of the subject matter disclosed herein the method comprises: arranging a load-coupling guard at least partly surrounding the load coupling, the confined volume being at least partly delimited by the load-coupling guard; and forcedly circulating cooling air between the load coupling and the load-coupling guard, whereby removing heat from the load coupling.

In further embodiments, the method can additionally comprise: causing cooling air to escape from the confined volume at at least a first end of the load-coupling guard facing the power turbine, whereby a stream of cooling air exiting the confined volume at the first end of the load-coupling guard is directed against the power turbine. In some embodiments the method can further comprises: causing cooling air to escape from the confined volume at at least a second end of the load-coupling guard facing the load, whereby a stream of cooling air exiting the confined volume at the second end of the load-coupling guard is directed away from the power turbine and towards the load. The second end of the load-coupling guard can open toward the environment, that is, outside the turbine package.

According to some exemplary embodiments, the method comprises: arranging the gas turbine in a gas turbine package; generating a cooling air stream to cool a casing of said gas turbine; deviating a fraction of said cooling air stream towards the confined volume partly surrounding the load coupling.

The gas turbine package usually also comprises a load compartment between the gas turbine and the load. The load coupling and the confined volume surrounding the load coupling can be arranged at least partly in the load compartment and cooling air can be circulated partly also in the confined volume and partly in the load compartment.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A gas turbine comprising:
a compressor;
a power turbine;
a load coupling connecting the gas turbine to a load;
a gas turbine package comprising a turbomachinery compartment housing the gas turbine;
a load-coupling guard at least partly surrounding the load coupling;
a cooling air circulation system for circulating cooling air in the turbomachinery compartment; and
a cooling air channeling configured to circulate a cooling air flow from the cooling air circulation system in the load-coupling guard sufficient to remove heat from the load coupling.

2. The gas turbine according to claim 1, comprising an air forcing device configured to force cooling air in the turbomachinery compartment and through the cooling air channeling in the load-coupling guard.

3. The gas turbine according to claim 1, further comprising an air intake line in fluid communication with the cooling air circulation system and with the cooling air channeling.

4. The gas turbine according to claim 3, wherein the air intake line is in fluid communication with an air intake plenum, wherein combustion air enters the compressor from the air intake plenum.

5. The gas turbine according to claim 3, further comprising a filter arrangement configured to filter ambient air entering the air intake line.

6. The gas turbine according to claim 1, wherein the gas turbine is an aeroderivative gas turbine.

7. The gas turbine according to claim 1, wherein the load coupling is connected to a hot end of the gas turbine.

8. The gas turbine according to claim 3, wherein the load coupling and the load-coupling guard extend through an exhaust collector-diffuser assembly, which at least partly surrounds the load coupling and the load-coupling guard.

9. The gas turbine according to claim 1, further comprising:
a load compartment, through which the load coupling extends, wherein the cooling air circulation channeling is configured to deliver cooling air from the cooling air circulation system in the load compartment.

10. The gas turbine according to claim 9, wherein the gas turbine package comprises an air intake plenum, and wherein the turbomachinery compartment is located between the air intake plenum and the load compartment.

11. The gas turbine according to claim 9, wherein the cooling air channeling comprises an air port, wherein cooling air from the cooling air circulation system is forcedly circulated through the air port, and wherein at least a first ventilation duct fluidly connects the air port to the load-coupling guard and a second ventilation duct feeds cooling air into the load compartment.

12. The gas turbine according to claim 11, further comprising a third ventilation duct configured to feed cooling air into the load compartment.

13. The gas turbine according to claim 12, wherein the second ventilation duct and the third ventilation duct are arranged substantially symmetrically at opposite sides of the first ventilation duct.

14. The gas turbine according to claim 1, wherein the load-coupling guard has a first end and a second end, the first end facing the power turbine and the second end facing the load connected to the load coupling, wherein at least the first end is open, whereby cooling air escaping from the load-coupling guard is directed towards the power turbine.

15. The gas turbine according to claim 14, wherein the second end is open, whereby cooling air escaping from the load-coupling guard is directed towards the load.

16. The gas turbine according to claim 8, wherein the load-coupling guard has a first end and a second end, the first end facing the power turbine and the second end facing the load connected to the load coupling, wherein the first end is open, whereby cooling air escaping from the load-coupling guard is directed towards the power turbine, and wherein the first end of the load-coupling guard is arranged in a hollow space at least partly surrounded by the exhaust collector-diffuser assembly, whereby cooling air exiting the load-coupling guard cools the exhaust collector-diffuser assembly.

17. The gas turbine according to claim 14, wherein the load coupling comprises at least a mechanical joint and a shaft.

18. A system comprising the gas turbine of claim 1, wherein the load is driven by the gas turbine.

19. A method of reducing heat and mechanical stresses on a load coupling in a gas turbine, the gas turbine comprising at least a compressor, a power turbine arranged in a turbomachinery compartment of a gas turbine package, and a load coupling which connects the gas turbine to a load, the method comprising:
generating a cooling air stream to cool a casing of the gas turbine; and
diverting a fraction of the cooling air stream upstream of the turbomachinery compartment and forcing the fraction of cooling air stream around the load coupling for removing heat from the load coupling by forcing cooling air around the load coupling.

20. The method according to claim 19, wherein an air forcing device delivers cooling air through the turbomachinery compartment and around the load coupling.

21. The method according to claim 19, further comprising:
defining a confined volume at least partly surrounding the load coupling; and
forcedly circulating the fraction of cooling air stream in the confined volume to remove heat from the load coupling.

22. The method according to claim 21, further comprising:
providing the load-coupling guard at least partly surrounding the load coupling, the confined volume being at least partly delimited by the load-coupling guard; and
forcedly circulating cooling air between the load coupling and the load-coupling guard to remove heat from the load coupling.

23. The method according to claim 22, further comprising causing cooling air to escape the confined volume at at least a first end of the load-coupling guard facing the power turbine, whereby a stream of cooling air exiting the confined volume at the first end of the load-coupling guard is directed against the power turbine.

24. The method according to claim 22, further comprising causing cooling air to escape the confined volume at at least a second end of the load-coupling guard facing the load, whereby a stream of cooling air exiting the confined volume at the second end of the load-coupling guard is directed away from the power turbine and towards the load.

25. The method according to claim 21, further comprising:
providing a load compartment between the gas turbine and the load;
at least partly arranging the load coupling and the confined volume surrounding the load coupling in the load compartment; and
feeding the cooling air partly in the confined volume and partly in the load compartment.

26. A gas turbine comprising:
a compressor;
a power turbine;
a load coupling connecting the gas turbine to a load;
a load-coupling guard at least partly surrounding the load coupling;
a cooling air channeling configured to circulate a cooling air flow in the load-coupling guard sufficient to remove heat from the load coupling;
a gas turbine package comprising a turbomachinery compartment housing the gas turbine;
a cooling air circulation system configured to circulate cooling air in the turbomachinery compartment; and
a load compartment, the load coupling extending through the load compartment,
wherein the cooling air channeling comprises an air port, wherein cooling air from the cooling air circulation system is forcedly circulated through the airport, and wherein at least a first ventilation duct fluidly connects the air port to the load-coupling guard and a second ventilation duct feeds cooling air in the load compartment.
